(19) United States
(12) Patent Application Publication
(10) Pub. No.: US 2026/0150072 A1
(43) Pub. Date: May 28, 2026

(54) CONFIGURING REFERENCE SIGNAL COMMUNICATION FOR MULTIPLE DEVICES

(71) Applicant: Lenovo (Singapore) Pte. Ltd., Singapore (SG)

(72) Inventors: Karthikeyan Ganesan, Nauheim (DE); Robin Rajan Thomas, Bad Nauheim (DE)

(21) Appl. No.: 19/112,575

(22) PCT Filed: Oct. 2, 2023
(86) PCT No.: PCT/IB2023/059873

§ 371 Date: Mar. 17, 2025

Related U.S. Application Data
(60) Provisional application No. 63/411,891, filed on Sep. 30, 2022.

(51) Int. Cl. H04W 64/00; H04L 27/26

(52) U.S. Cl. CPC H04W 64/00; H04L 27/2659

(57) ABSTRACT

OF THE DISCLOSURE Apparatuses, methods, and systems are disclosed for configuring reference signal communication for multiple devices. One method (800) includes receiving (802), at a user equipment (“UE”), an inter-UE coordination (“IUC”) configuration for sidelink (“SL”) positioning reference signal (“PRS”) communication. The IUC configuration includes, for a plurality of UEs, a resource element offset or a frequency offset, or both. The method (800) includes transmitting (804) IUC information to the plurality of UEs based at least in part on the IUC configuration and a change to the resource element offset or the frequency offset, or both, and the IUC information includes preferred information, non-preferred information, and resource conflict information for the SL PRS communication.

### FIELD

The subject matter disclosed herein relates generally to wireless communications and more particularly relates to configuring reference signal communication for multiple devices.

### BACKGROUND

In certain wireless communications systems, positioning methods may be user equipment (“UE”) assisted. In such systems, the positioning methods may be inefficient.

### BRIEF SUMMARY

Methods for configuring reference signal communication for multiple devices are disclosed. Apparatuses and systems also perform the functions of the methods. One embodiment of a method includes receiving, at a UE, an inter-UE coordination (“IUC”) configuration for sidelink (“SL”) positioning reference signal (“PRS”) communication. The IUC configuration includes, for a plurality of UEs, a resource element offset or a frequency offset, or both. In some embodiments, the method includes transmitting IUC information to the plurality of UEs based at least in part on the IUC configuration and a change to the resource element offset or the frequency offset, or both, and the IUC information includes preferred information, non-preferred information, and resource conflict information for the SL PRS communication.

One apparatus for configuring reference signal communication for multiple devices includes a processor. In some embodiments, the apparatus includes a memory coupled to the processor, the processor configured to cause the apparatus to: receive an IUC configuration for SL PRS communication, wherein the IUC configuration includes, for a plurality of UEs, a resource element offset or frequency offset, or both; and transmit IUC information to the plurality of UEs based at least in part on the IUC configuration and a change to the resource element offset or the frequency offset, or both, and the IUC information includes preferred information, non-preferred information, and resource conflict information for the SL PRS communication.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring reference signal communication for multiple devices;

FIG. 2 is a schematic block diagram illustrating one embodiment of an apparatus that may be used for configuring reference signal communication for multiple devices;

FIG. 3 is a schematic block diagram illustrating one embodiment of an apparatus that may be used for configuring reference signal communication for multiple devices;

FIGS. 4A and 4B are schematic block diagrams illustrating one embodiment of inter UE coordination schemes;

FIG. 5 is a schematic block diagram illustrating one embodiment of a system having an inter UE coordinating scheme including an IUC request;

FIG. 6 is a schematic block diagram illustrating one embodiment of a system having an inter UE coordinating scheme including a PRS request;

FIG. 7 is a schematic block diagram illustrating one embodiment of a system having anchor UEs that coordinate using IUC information; and

FIG. 8 is a flow chart diagram illustrating one embodiment of a method for configuring reference signal communication for multiple devices.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

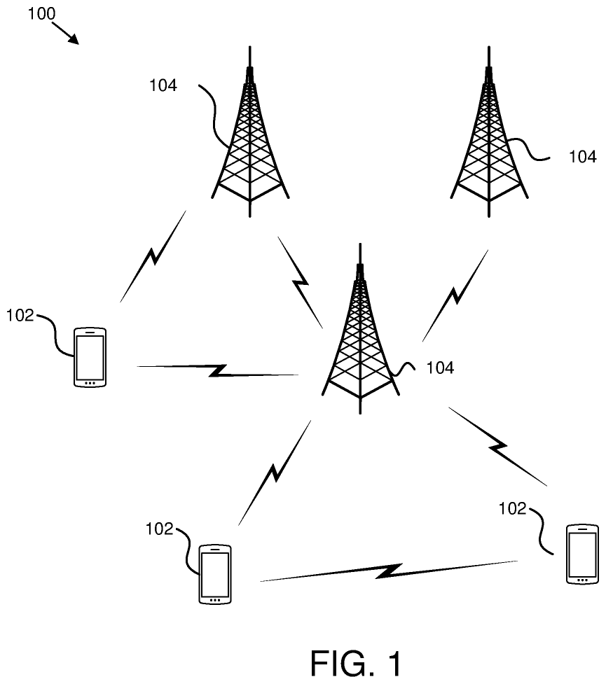

FIG. 1 depicts an embodiment of a wireless communication system 100 for configuring reference signal communication for multiple devices. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an orthogonal frequency division multiplexing (“OFDM”)modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive an IUC configuration for SL PRS communication. The IUC configuration includes, for a plurality of UEs, a resource element offset or a frequency offset, or both. In some embodiments, the remote unit 102 may transmit IUC information to the plurality of UEs based at least in part on the IUC configuration and a change to the resource element offset or the frequency offset, or both, and the IUC information includes preferred information, non-preferred information, and resource conflict information for the SL PRS communication. Accordingly, the remote unit 102 may be used for configuring reference signal communication for multiple devices.

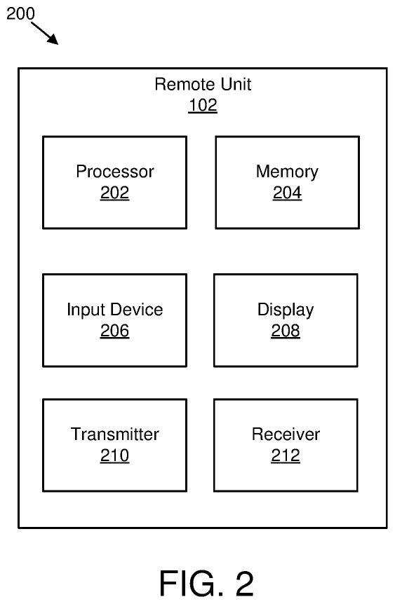

FIG. 2 depicts one embodiment of an apparatus 200 that may be used for configuring reference signal communication for multiple devices. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the apparatus to: receive an IUC configuration for SL PRS communication, wherein the IUC configuration includes, for a plurality of UEs, a resource element offset or frequency offset, or both; and transmit IUC information to the plurality of UEs based at least in part on the IUC configuration and a change to the resource element offset or the frequency offset, or both, and the IUC information includes preferred information, non-preferred information, and resource conflict information for the SL PRS communication.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

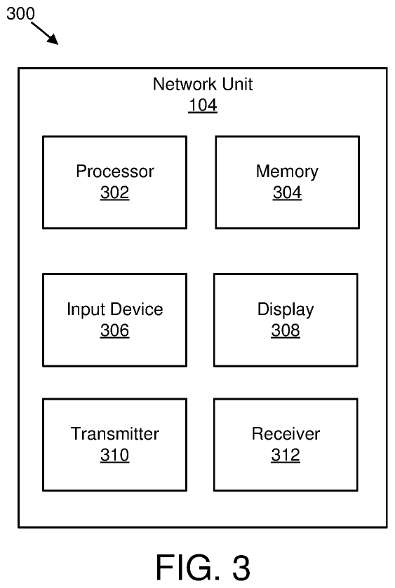

FIG. 3 depicts one embodiment of an apparatus 300 that may be used for configuring reference signal communication for multiple devices. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments of NR, there may be sidelink positioning enhancement considering vehicle to everything (“V2X”), commercial devices, and IIoT. Although there exists a network based absolute positioning framework, which enables UE-assisted and UE-based positioning methods, there may not be efficient UE-to-UE relative positioning, range, and/or orientation determination for different vertical services (e.g., V2X, public safety, IIoT, commercial, and so forth). In some embodiments, NR V2X positioning may be used for in-coverage, partial coverage, and out-of-coverage scenarios.

In various embodiments, such as in network based positioning, location management function (“LMF”) configures DL PRS through DL positioning frequency layer (“PFL”) and DL PRS resources to the target and/or initiator UE over a location protocol (“LPP”) containing PRS configurations received from serving and neighboring gNBs, positioning type (e.g., angle of arrival (“AoA”), round trip time (“RTT”), time difference of arrival (“TDOA”, “TDoA”), etc.), and measurement reporting.

In certain embodiments, DL PRS may be transmitted in beams. A DL PRS beam is referred to as a DL PRS resource while the full set of PRS beams transmitted from a transmission and reception point (“TRP”) on the same frequency is referred to as a DL PRS resource set. Comb pattern and muting pattern may be configured per resource set.

In some embodiments, there may be an inter-UE coordination method and procedure for SL PRS considering resource sharing with anchor UEs for a certain positioning technique such as to avoid a half duplex problem.

In various NR embodiments, there are different inter-UE coordination schemes as follows: 1) scheme 1a—preferred resource set; 2) scheme 1b—non-preferred resource set; and/or scheme 2—expected and/or potential resource conflict indication on the reserved resources. In scheme 1a and scheme 1b, a UE-A sends a set of resource transmitted to a UE-B based on explicit triggering information received from the UE-B or condition based triggering. The signaling container for transmitting the explicit request and transmitting a set of resources is based on MAC CE and/or sidelink control information (“SCI”).

In certain embodiments, the schemes of inter-UE coordination in mode 2 are categorized as being based on the following types of “A set of resources” sent by UE-A to UE-B: 1) UE-A sends to UE-B the set of resources preferred for UE-B's transmission (e.g., based on its sensing result); 2) UE-A sends to UE-B the set of resources not preferred for UE-B's transmission (e.g., based on its sensing result and/or expected and/or potential resource conflict); and/or 3) UE-A sends to UE-B the set of resource where the resource conflict is detected (e.g., in some configurations there may be details of resource conflicts such as including a type of resource conflict, details of sensing operation at UE-A side, and/or which types of resource set information are beneficial and/or feasible to which cast types-these different types may be used in combination with each other). In some embodiments, an LS may be sent to a RAN plenary.

In various embodiments, for the schemes of inter-UE coordination identified as feasible and/or beneficial, at least the following aspects may be determined: 1) how and/or when UE-A determines the contents of “A set of resources”, including consideration of UL scheduling; 2) when UE-A sends “A set of resources” to UE-B, including which UEs sends it; 3) how UE-A and UE-B are determined; 4) how UE-A sends “A set of resources” to UE-B, including container used for carrying it, implicitly or explicitly or both; 5) how, when, and/or whether UE-B receives “A set of resources” and takes it into account in the resource selection for its own transmission; and/or 6) how and/or whether to define the relationship between support and/or signaling of inter-UE coordination and cast type.

As used herein, the term eNB and/or gNB are used for a base station but it is replaceable by any other radio access node (e.g., base station (“BS”), eNB, gNB, AP, NR, and so forth). Further, different embodiments may be described in the context of 5G NR; however, the embodiments are also equally applicable to other mobile communication systems supporting serving cells and/or carriers being configured for sidelink communication over UE-to-UE (“PC5”) interface.

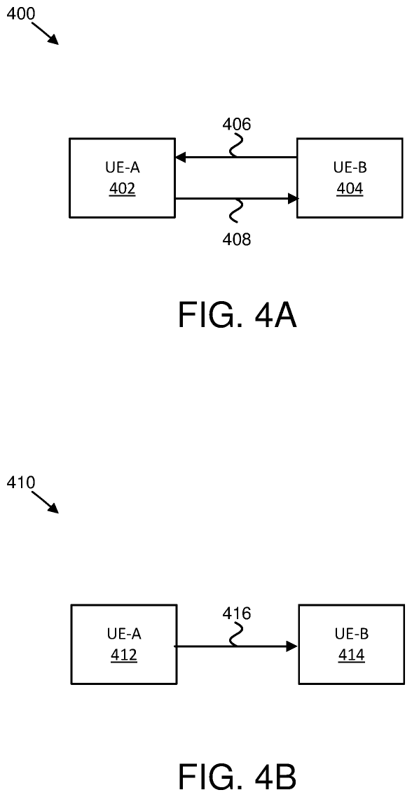

FIGS. 4A and 4B are schematic block diagrams illustrating one embodiment of inter UE coordination schemes. In a first set of inter UE coordination schemes 400, there is a UE-A 402 and a UE-B 404. The UE-B 404 sends an explicit request 406, and the UE-A 402 sends an inter-UE coordination message 408 (e.g., for scheme 1a or scheme 1b). In a second set of inter UE coordination schemes 410, there is a UE-A 412 (e.g., condition based trigger) and a UE-B 414. The UE-A 412 transmits an inter UE coordination message 416 (e.g., for scheme 1a, 1b, and 2).

In a first embodiment, a sidelink positioning technique, such as TDoA, multi-UE RTT requires a target UE to transmit and receive SL PRS from multiple anchor UEs. These anchor UEs support positioning for a target UE (e.g., by transmitting and/or receiving reference signals for positioning, providing positioning-related information, and so forth), over a SL interface. Also resource coordination is needed among number of transmitting UEs to align the SL PRS resources.

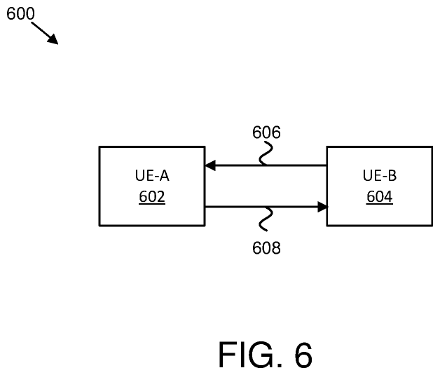

Preferred resource set: Transmitting UE may receive preferred resource set containing PRS resource in one or more combination of PRS resource id, PRS resource within the resource set, PRS slot information, PRS bandwidth information, comb pattern and resource element offset/frequency offset within PRS resource to efficiently multiplex PRS signal from multiple transmitters. The transmitting UE may receive the PRS preferred resource set and may perform resource reselection to select one or more of the above resource combination in candidate resource selection. In a preferred resource set, a TX UE transmitting SL PRS may be a target UE (e.g., anchor UEs which need to exchange PRS resource configuration using an IUC message including IUC information. The IUC information may be needed to be exchanged between a target UE and anchor UEs so that the target UE may transmit the PRS request towards one or more anchor UEs as shown in FIG. 6 and may indicate preferred transmission of SL PRS from the anchor UE to the target UE which may include a time-frequency resource, slot information, a PRS length, a PRS bandwidth, a PRS resource set identifier (“ID”), a comb pattern, and/or a resource element offset for each anchor UE transmitting SL PRS which may be implicitly determined by a certain rule or explicitly indicated in signaling. The IUC information may be signaled using the MAC CE, SCI and using LPP signaling. A new configuration message for IUC signaling may be added to the LPP container.

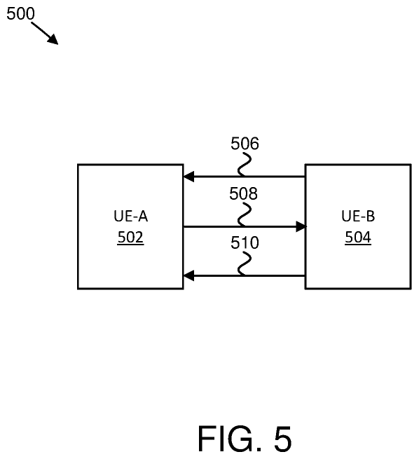

FIG. 5 is a schematic block diagram illustrating one embodiment of a system 500 having an inter UE coordinating scheme including an IUC request. The system 500 includes a UE-A 502 (e.g., anchor UE) and a UE-B 504 (e.g., target UE). The UE-B 504 sends an explicit request for IUC 506, the UE-A 502 sends an IUC message 508 (e.g., preferred or non-preferred resource set), and the UE-B 504 send a SL PRS 510.

FIG. 6 is a schematic block diagram illustrating one embodiment of a system 600 having an inter UE coordinating scheme including a PRS request. The system 600 includes a UE-A 602 (e.g., anchor UE) and a UE-B 604 (e.g., target UE). The UE-B 604 sends an explicit request for SL PRS+IUC message 606 (e.g., preferred or non-preferred resource set), and the UE-A 602 send a SL PRS 608.

In one implementation of the first embodiment, a SL TDoA technique requires transmission of SL PRS from multiple anchor UEs towards the target UE in the same time slot and reduction of interference of each TX UE transmitting SL PRS in a comb size using a distinct resource element offset. Hence, the TX UE may transmit a PRS request containing a PRS configuration such as a PRS time-frequency resource, a length, a bandwidth, a comb pattern, and/or a PRS resource element offset for each anchor UE transmitting SL PRS.

In another implementation of the first embodiment, one or more anchor UEs may autonomously select a resource element offset according to an anchor UE ID and/or member ID.

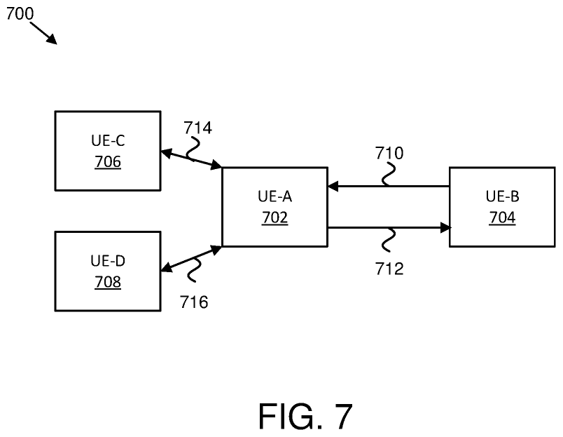

In a further implementation of the first embodiment, after receiving the PRS request, one or more anchor UEs may coordinate the time-frequency resource, comb pattern, and UE specific resource element offset for transmitting SL PRS as shown in FIG. 7.

FIG. 7 is a schematic block diagram illustrating one embodiment of a system 700 having anchor UEs that coordinate using IUC information. The system 700 includes a UE-A 702 (e.g., anchor UE), a UE-B 704 (e.g., target UE), a UE-C 706 (e.g., anchor UE), and a UE-D 708 (e.g., anchor UE). The UE-B 704 sends an explicit request for SL PRS message 710, and the UE-A 702 send a SL PRS 712. Moreover, the UE-A 702 send IUC coordination messages 714 and 716.

In certain embodiments, an expected and/or potential resource conflict may be detected if PRS resources are fully and/or partially overlapping in time-and-frequency with other UEs reserved resources having the same or multiple comb sizes and the same resource element offset while a PRS reference signal received power (“RSRP”) (“PRS-RSRP”) measurement is larger than a configured (or preconfigured) PRS-RSRP threshold compared to the PRS-RSRP measurement of a UE-B's reserved resource. The resource conflict information may be transmitted using MAC CE, SCI, or using LPP signaling indicating the time slot, comb pattern, resource element offset within the slot for a comb size to help other UE reselect the PRS resource in any combination of time-frequency resource, comb size, and/or resource element offset.

In some embodiments, there may be an always on model in which roadside units (“RSUs”) as anchor UEs transmit SL PRS and may coordinate PRS configuration with other anchor UEs using the IUC information.

Non-preferred resource set: Transmitting UE may receive non-preferred resource set containing PRS resource id, PRS resource within the resource set, PRS slot information, PRS bandwidth information, comb pattern and resource element offset/frequency offset within PRS resource, repetition of PRS within a resource set. Such non-preferred resource set may be considered as different muting patterns considering different combination of non preferred resource set. UE after receiving the non preferred resource set or muting pattern information as part of the IUC information may choose not to transmit or transmit zero power PRS.

In various embodiments, a muting pattern may be provided by a target UE towards anchor UEs as part of a non-preferred resource and the muting pattern may contain configuration for zero energy PRS.

In another implementation, the muting pattern may include repetition of PRS within a resource set, within a resource pool or excluding some beam id. In another implementation, muting pattern option 1 may contains PRS slot information, PRS frequency information, muting pattern option 2 may contain repetition information of PRS within a resource set and/or resource pool, muting pattern 3 may contain comb pattern and/or resource element/frequency offset within a PRS resource, and a muting pattern may be a combination of another muting pattern option.

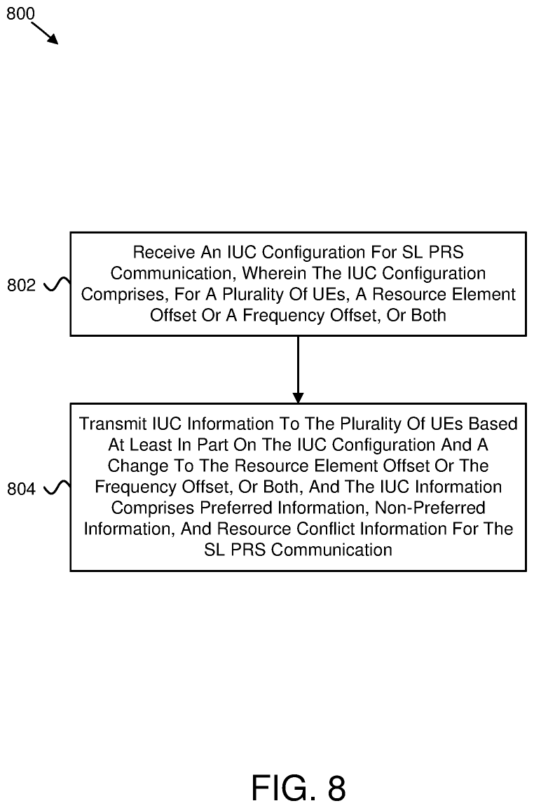

FIG. 8 is a flow chart diagram illustrating one embodiment of a method 800 for configuring reference signal communication for multiple devices. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802 an IUC configuration for SL PRS communication. The IUC configuration includes, for a plurality of UEs, a resource element offset or a frequency offset, or both. In some embodiments, the method 800 includes transmitting 804 IUC information to the plurality of UEs based at least in part on the IUC configuration and a change to the resource element offset or the frequency offset, or both, and the IUC information includes preferred information, non-preferred information, and resource conflict information for the SL PRS communication.

In certain embodiments, the IUC configuration comprises, for the plurality of UEs, a time-frequency resource, a comb size, a PRS length, or a combination thereof. In some embodiments, the method 800 further comprises: determining, for the plurality of UEs, the change to the resource element offset or the frequency offset, or both; and determining the ICU information for the plurality of UEs based at least in part on the determined change to the resource element offset or the frequency offset, or both. In various embodiments, the method 800 further comprises autonomously selecting the resource element offset according to an anchor UE ID, a member ID, or a combination thereof.

In one embodiment, the method 800 further comprises providing a muting pattern to anchor UEs as part of a non-preferred resource, wherein the muting pattern comprises a configuration for zero energy PRS. In certain embodiments, the method 800 further comprises detecting a potential resource conflict in response to PRS resources at least partially overlapping in time-and-frequency with other resources having: a same resource element offset; and a same comb size or a multiple of the same comb size.

In one embodiment, an apparatus for wireless communication, the apparatus comprises: a processor; a memory coupled to the processor, the processor configured to cause the apparatus to: receive an IUC configuration for SL PRS communication, wherein the IUC configuration comprises, for a plurality of UEs, a resource element offset or frequency offset, or both; and transmit IUC information to the plurality of UEs based at least in part on the IUC configuration and a change to the resource element offset or the frequency offset, or both, and the IUC information comprises preferred information, non-preferred information, and resource conflict information for the SL PRS communication.

In certain embodiments, the processor is further configured to cause the apparatus to autonomously select the resource element offset according to an anchor UE ID, a member ID, or a combination thereof.

In some embodiments, the processor is further configured to cause the apparatus to provide a muting pattern to anchor UEs as part of a non-preferred resource, and the muting pattern comprises a configuration for zero energy PRS.

In various embodiments, the processor is further configured to cause the apparatus to detect a potential resource conflict in response to PRS resources at least partially overlapping in time-and-frequency with other resources having: a same resource element offset; and a same comb size or a multiple of the same comb size.

In one embodiment, the IUC configuration comprises, for the plurality of UEs, a time-frequency resource, a comb size, a PRS length, or a combination thereof.

In certain embodiments, the processor is further configured to cause the apparatus to: determine, for the plurality of UEs, the change to the resource element offset or the frequency offset, or both; and determine the ICU information for the plurality of UEs based at least in part on the determined change to the resource element offset or the frequency offset, or both.

In one embodiment, a method at a UE, the method comprises: receiving an IUC configuration for SL PRS communication, wherein the IUC configuration comprises, for a plurality of UEs, a resource element offset or a frequency offset, or both; and transmitting IUC information to the plurality of UEs based at least in part on the IUC configuration and a change to the resource element offset or the frequency offset, or both, and the IUC information comprises preferred information, non-preferred information, and resource conflict information for the SL PRS communication.

In certain embodiments, the IUC configuration comprises, for the plurality of UEs, a time-frequency resource, a comb size, a PRS length, or a combination thereof.

In some embodiments, the method further comprises: determining, for the plurality of UEs, the change to the resource element offset or the frequency offset, or both; and determining the ICU information for the plurality of UEs based at least in part on the determined change to the resource element offset or the frequency offset, or both.

In various embodiments, the method further comprises autonomously selecting the resource element offset according to an anchor UE ID, a member ID, or a combination thereof.

In one embodiment, the method further comprises providing a muting pattern to anchor UEs as part of a non-preferred resource, wherein the muting pattern comprises a configuration for zero energy PRS.

In certain embodiments, the method further comprises detecting a potential resource conflict in response to PRS resources at least partially overlapping in time-and-frequency with other resources having: a same resource element offset; and a same comb size or a multiple of the same comb size.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-20. (canceled)

21. A user equipment (UE), comprising:
at least one memory; and
at least one processor coupled with the at least one memory and configured to cause the UE to:
receive an inter-UE coordination (IUC) configuration for transmission of sidelink (SL) positioning reference signal (PRS); and
transmit IUC information based at least in part on the IUC configuration.

22. The UE of claim 21, wherein the IUC configuration comprises one or more of a resource element offset or a frequency offset.

23. The UE of claim 22, wherein the IUC information is transmitted based at least in part on a change to one or more of the resource element offset or the frequency offset.

24. The UE of claim 23, wherein the at least one processor is configured to cause the UE to:
determine the change to one or more of the resource element offset or the frequency offset; and
determine the IUC information based at least in part on the determined change to one or more of the resource element offset or the frequency offset.

25. The UE of claim 23, wherein the at least one processor is configured to cause the UE to:
autonomously select the resource element offset based on an identifier of an anchor UE.

26. The UE of claim 21, wherein the at least one processor is configured to cause the UE to:
provide a muting pattern to one or more anchor UEs as part of a non-preferred resource,
wherein the muting pattern comprises a configuration for zero energy PRS.

27. The UE of claim 21, wherein the at least one processor is configured to cause the UE to:
detect a potential resource conflict in response to one or more PRS resources partially overlapping in with other resources having one or more of a same resource element offset, a same comb size, or a multiple of the same comb size.

28. The UE of claim 21, wherein the IUC configuration comprises one or more of a time-frequency resource, a comb size, a PRS length, or a combination thereof.

29. The UE of claim 21, wherein the IUC information comprises preferred information, non-preferred information, and resource conflict information for the transmission of SL PRS.

30. A method for wireless communication at a user equipment (UE), the method comprising:
receiving an inter-UE coordination (IUC) configuration for transmission of sidelink (SL) positioning reference signal (PRS); and
transmitting IUC information based at least in part on the IUC configuration.

31. The method of claim 30, wherein the IUC configuration comprises one or more of a resource element offset or a frequency offset.

32. The method of claim 31, wherein the IUC information is transmitted based at least in part on a change to one or more of the resource element offset or the frequency offset.

33. The method of claim 32, further comprising:
determining the change to one or more of the resource element offset or the frequency offset; and
determining the IUC information based at least in part on the determined change to one or more of the resource element offset or the frequency offset.

34. The method of claim 32, further comprising:
autonomously selecting the resource element offset based on an identifier of an anchor UE.

35. The method of claim 30, further comprising:
providing a muting pattern to one or more anchor UEs as part of a non-preferred resource,
wherein the muting pattern comprises a configuration for zero energy PRS.

36. The method of claim 30, further comprising:
detecting a potential resource conflict in response to one or more PRS resources partially overlapping in with other resources having one or more of a same resource element offset, a same comb size, or a multiple of the same comb size.

37. The method of claim 30, wherein the IUC configuration comprises one or more of a time-frequency resource, a comb size, a PRS length, or a combination thereof.

38. The method of claim 30, wherein the IUC information comprises preferred information, non-preferred information, and resource conflict information for the transmission of SL PRS.

39. A user equipment (UE), comprising:
at least one memory; and
at least one processor coupled with the at least one memory and configured to cause the UE to:
transmit an inter-UE coordination (IUC) configuration for transmission of sidelink (SL) positioning reference signal (PRS); and
receive IUC information based at least in part on the IUC configuration.

40. A method for wireless communication at a user equipment (UE), the method comprising:
transmitting an inter-UE coordination (IUC) configuration for transmission of sidelink (SL) positioning reference signal (PRS); and
receiving IUC information based at least in part on the IUC configuration.
